(19) United States
(12) Patent Application Publication
(10) Pub. No.: US 2022/0250284 A1
(43) Pub. Date: Aug. 11, 2022

(54) METHOD OF MAKING A DISPENSER

(71) Applicant: TOO CHARMING ENT. CO., LTD., Lugang Township (TW)

(72) Inventor: CHEN-CHANG KUO, LUGANG TOWNSHIP (TW)

(21) Appl. No.: 17/174,347

(22) Filed: Feb. 11, 2021

(51) Int. Cl. B29B 9/14; B29C 45/00; B29C 51/00; B29C 51/02; B29C 45/18; B29B 7/90

(52) U.S. Cl. CPC B29B 9/14; B29C 45/0001; B29C 51/002; B29C 51/02; B29L 2031/718; B29B 7/90; B29K 2003/00; B29K 2005/00; B29C 45/18

(57) ABSTRACT

A method of making a dispenser includes: mixing a plurality of materials, the materials including plant fiber, vegetable gum, starch, a toughening agent, and a dispersing agent; utilizing a granulator to form the mixture of the plant fiber, the vegetable gum, the starch, the toughening agent, and the dispersing agent into pellets; and forming a dispenser by moving the pellets into a processing machine; wherein the processing machine melts the pellets and disposes the melted material into a cavity configured as a forming mold, and after cooling the dispenser is obtained.

### BACKGROUND OF INVENTION

### Field of Invention

The present invention relates to a method of making a dispenser, and more particular to a method of making a biodegradable dispenser.

### Description of Related Art

Most everyone puts some care products on their body for various reasons, and the product are stored in some kind of dispenser. At present, the main source of raw materials for the dispenser is plastic. The dispenser made of plastic cannot be naturally decomposed in the soil after being discarded and buried. If the dispenser is burned and incinerated, it produces a lot of dense smoke and toxic gases, which causes serious pollution to the air, water and soil that humans, animals, and plants depend for their livelihoods. It is not environmentally friendly to use.

Therefore, it is desirable to provide a method of making a dispenser to mitigate and/or obviate the aforementioned problems.

### SUMMARY OF INVENTION

An objective of present invention is to provide a method of making a dispenser, which is capable of improving the above-mention problems.

In order to achieve the above mentioned objective, a method of making a dispenser includes: mixing a plurality of materials, the materials including plant fiber, vegetable gum, starch, a toughening agent, and a dispersing agent; utilizing a granulator to form the mixture of the plant fiber, the vegetable gum, the starch, the toughening agent, and the dispersing agent into pellets; and forming a dispenser by moving the pellets into a processing machine; wherein the processing machine melts the pellets and disposes the melted material into a cavity configured as a forming mold, and after cooling the dispenser is obtained.

Other objects, advantages, and novel features of invention will become more apparent from the following detailed description when taken in conjunction with the accompanying drawings.

### BRIEF DESCRIPTION OF DRAWINGS

FIG. 1 is a flow diagram of the present invention.

FIG. 2 is a schematic diagram of mixing raw materials and generating pellets according to the present invention.

FIG. 3 is the processing schematic diagram of the injection molding of the present invention.

FIG. 4 is an exploded perspective view of a first preferred embodiment of the present invention.

FIG. 5 is a combined cross-sectional view of the first preferred embodiment of the present invention.

FIG. 6 is a perspective view of a second preferred embodiment of the present invention.

FIG. 7 is a cross-sectional view of the second preferred embodiment of the present invention.

### DETAILED DESCRIPTION OF PREFERRED EMBODIMENT

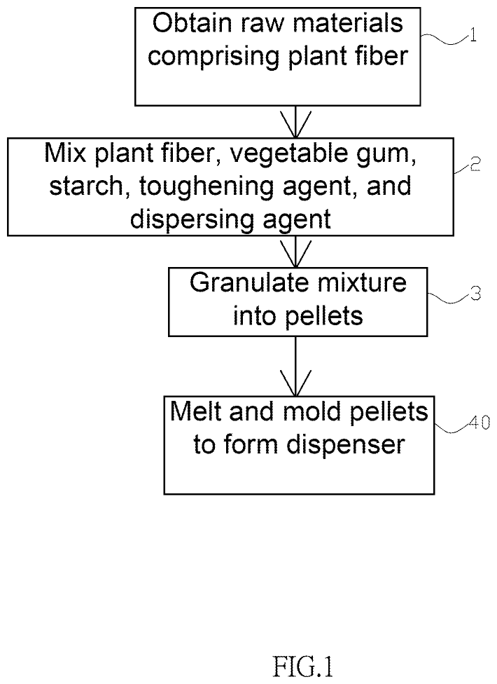

Please refer to FIG. 1, a method of making a dispenser 40 as disclosed in the present invention comprises: mixing a plurality of materials; utilizing a granulator to form the mixture of the plant fiber 11, the vegetable gum 12, the starch 13, the toughening agent 14, and the dispersing agent 15 into pellets 10; and forming a dispenser 40 by moving the pellets 10 into a processing machine 20.

The plant fiber 11 is the main material for the dispenser 40. Since the main raw material is obtained from pure natural plants, it is not like plastic that produces toxic gases and dense smoke after burning, and it can be naturally decomposed after being covered, so as to achieve the environmental protection advantage.

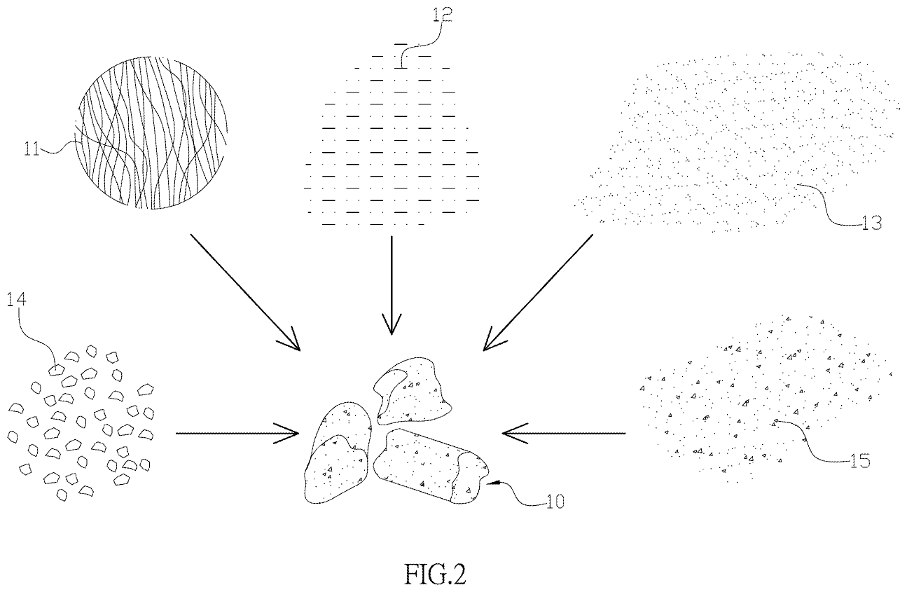

Next, the plant fiber 11 is mixed with the vegetable gum 12, the starch 13, the toughening agent 14 and the dispersing agent 15 and then the mixture is sent into the granulator to become the pellets 10, as shown in FIG. 2.

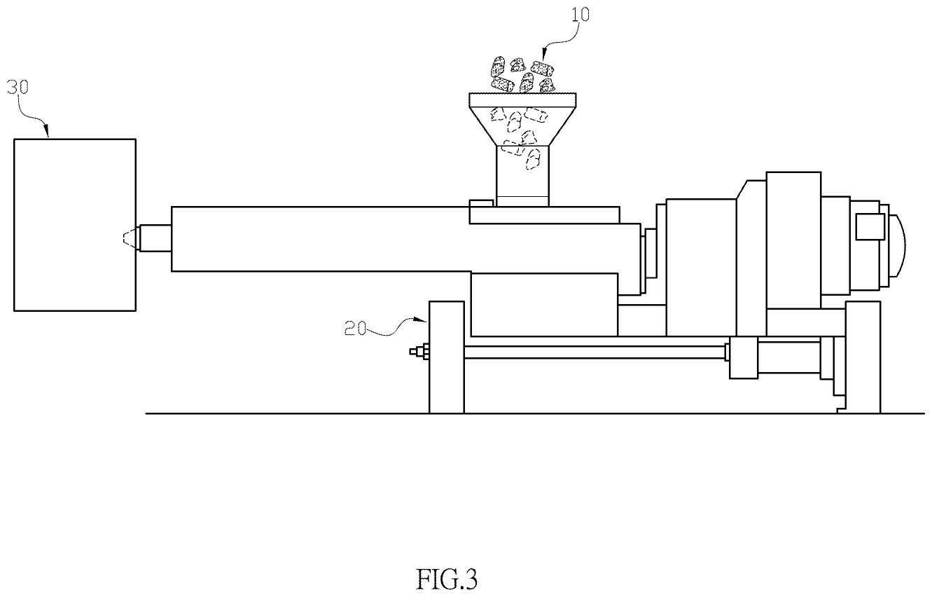

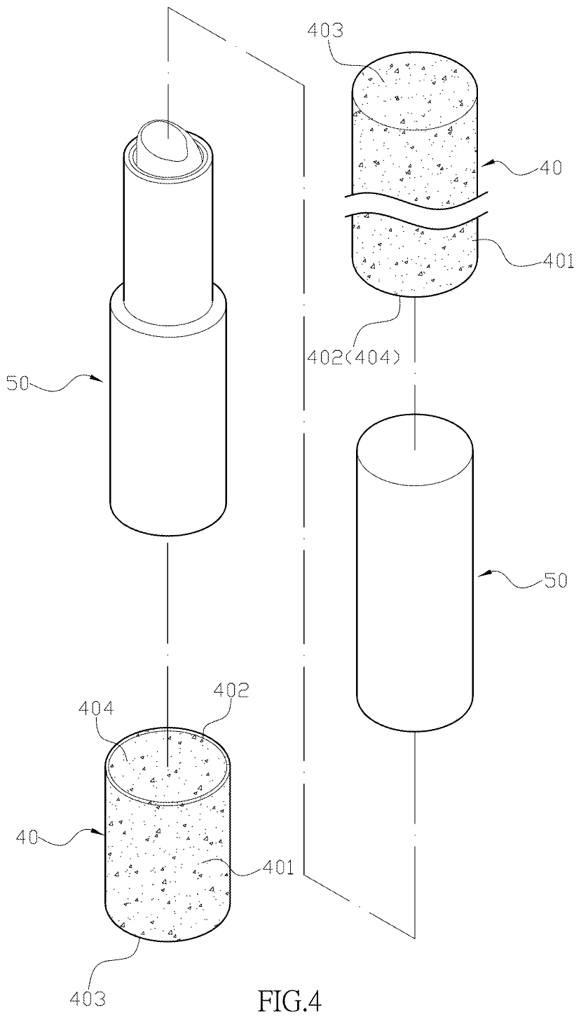

Then, the pellets 10 are sent in the processing machine 20 with a feed screw, as shown in FIG. 3. The processing machine 20 melts the pellets 10 and disposes the melted pellet into a cavity configured as a forming mold 30 and after cooling the dispenser 40 is obtained. The dispenser 40 has a ring wall 401, an open end 402 and a closed end 403, the ring wall 401 and the closed end 403 form an extended space 404 inside the dispenser 40, and the extended space 404 is connected to the open end 402. Therefore, with the combination of the extension space 404 and the open end 402, and the dispenser 40 is able to sleeve on the casing 50 of a cosmetic product, as shown in FIGS. 4-7.

Moreover, the pellets 10 need to be melt immediately and processed to form the dispenser, otherwise, the pellets 10 are not able to be used because the pellets 10 absorb moisture easily.

In addition, the processing machine 20 is a hot pressing machine with a feed screw.

Furthermore, the processing machine 20 is an injection molding machine with a feed screw.

Also, an inner surface of the forming mold 30 has a mirrored surface.

Additionally, the forming mold 30 comprises a fixed mold and a related movable mold, a combined tolerance of the fixed mold and the movable mold controlled below 0.03 mm.

Moreover, a tolerance of the dispenser 40 is controlled and fixed at 0.03 mm.

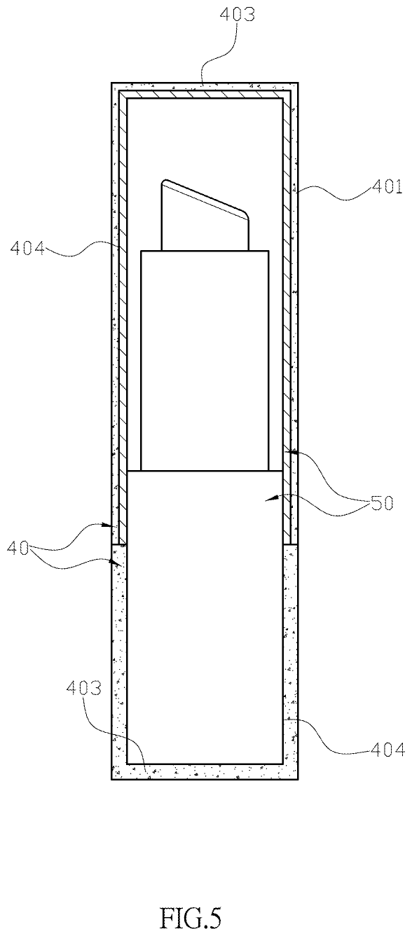

Additionally, the casing 50 is configured to pack lipstick, balm . . . etc. product, as shown in FIGS. 4 and 5.

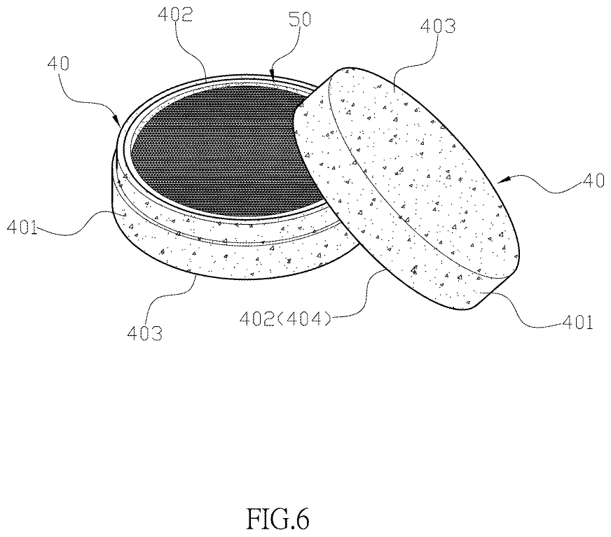

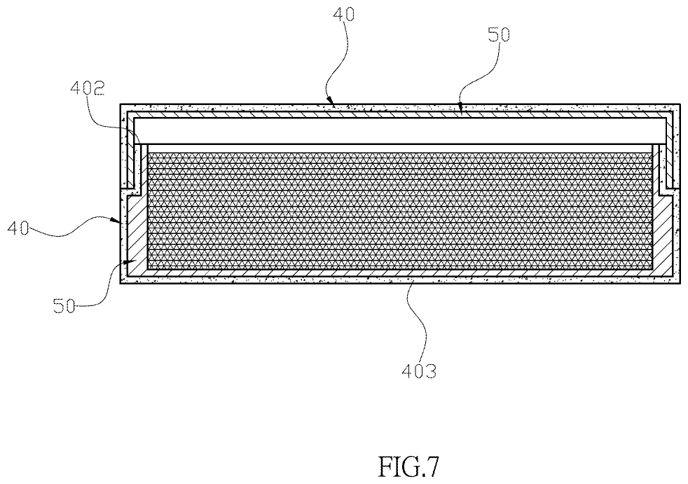

Also, the casing 50 is configured to pack cream, compacted powered . . . etc. product, as shown in FIGS. 6 and 7.

Also, the casing 50 is configured to pack eyeshadow, blush . . . etc. product.

In addition, the plant fiber is polylactide extracted from plants containing starch, such as corn starch, potato, cassava, wheat . . . , which even if it is treated by incineration, it does not produce any toxic chemicals, black smoke and odor, and it can be decomposed by composting facilities.

Moreover, the toughening agent is polubutylene succinate, which is a biodegradable polymer synthesized from butanedioic Acid and butanediol made from corn or sugar cane sugars.

In additional, the plant fiber is rice husk fiber or so-called agricultural waste (such as rice husks, wheat husks, corn stalks, coffee grounds . . . ).

Also, the dispersing agent is talc powder.

The above-mentioned method has following benefits:
1. Since the raw materials used in the production of the dispenser 40 are entirely derived from pure natural plants, it does not produce toxic gases and dense smoke after burning like plastic. It can be decomposed naturally when the disposal of dispenser 40 is covered, so even if the dispenser 40 is burned by incineration does not pollute the air, water and soil. Alternatively, the residues after directly buried or incinerated can be used as nutrients and fertilizers for plant growth, so as to achieve a green process with environmental protection and sustainable circulation.
2. The dispenser 40 is sleeved on the casing 50 of the cosmetics content, which is effectively reduce the amount of plastic used in the dispenser and relatively environmentally friendly.
3. Since the casing 50 and the dispenser 40 are a combination of multiple objects, which requires to be twisted or pulled to open, the toughening agent 14 is added to the mixing process to effectively increase the strength, torsion resistance and tensile strength of the dispenser 40, so that the dispenser 40 will not be easily damaged due to the force applied when opening and closing. Furthermore, the dispersing agent 15 is added to improve the mixing of the plant fiber 11 and the vegetable gum 12.
4. Since the main raw material of the plant fiber 11 is dryer after being heated and melted, it is necessary have a polished inner surface of the forming mold 30 to reduce frictional resistance.
5. The forming mold 30 is formed by combining a fixed mold and a movable mold, and the combined tolerance of the fixed mold and the movable mold must be controlled below 0.03 mm to prevent the plant fiber 11 from having flash after the feed screw is pressed and extruded with high horsepower and high hardness.

Although the present invention has been explained in relation to its preferred embodiment, it is to be understood that many other possible modifications and variations can be made without departing from the spirit and scope of invention as hereinafter claimed.

1. A method of making a dispenser comprising:
mixing a plurality of materials, the materials comprising plant fiber, vegetable gum, starch, a toughening agent, and a dispersing agent;
utilizing a granulator to form the mixture of the plant fiber, the vegetable gum, the starch, the toughening agent, and the dispersing agent into pellets; and
forming a dispenser by moving the pellets into a processing machine;
wherein the processing machine melts the pellets and disposes the melted material into a cavity configured as a forming mold, and after cooling the dispenser is obtained;
wherein the cavity is formed so that the dispenser has a ring wall, an open end and a closed end, the ring wall and the closed end forming an extended space inside the dispenser, the extended space connected to the open end.

2. The method of making a dispenser as claimed m claim 1, wherein the processing machine has a feed screw.

3. (canceled)

3. The method of making a dispenser as claimed in claim 1, wherein the processing machine is an injection molding machine with a feed screw.

4. The method of making a dispenser as claimed in claim 1, wherein an inner surface of the forming mold has a mirrored surface.

5. The method of making a dispenser as claimed in claim 1, wherein the forming mold comprises a fixed mold and a related movable mold, a combined tolerance of the fixed mold and the movable mold controlled below 0.03 mm.

6. The method of making a dispenser as claimed in claim 1, wherein a tolerance of the dispenser is controlled and fixed at 0.03 mm.
